(19) United States
(12) Patent Application Publication
(10) Pub. No.: US 2020/0312199 A1
(43) Pub. Date: Oct. 1, 2020

(54) LAYERS FOR PRODUCT PACKAGING

(71) Applicant: KONICA MINOLTA LABORATORY U.S.A., INC., San Mateo, CA (US)

(72) Inventors: Kenneth Huang YOUNG, San Mateo, CA (US); Randy Cruz SORIANO, San Leandro, CA (US); Ann Qiongying FENG, San Jose, CA (US)

(21) Appl. No.: 16/370,036

(22) Filed: Mar. 29, 2019

(51) Int. Cl. G09F 3/00; B32B 27/10; B32B 27/32; B32B 27/20

(52) U.S. Cl. CPC G09F 3/0291; B32B 27/10; B32B 27/32; B32B 27/20; B32B 2255/24; G09F 2003/0257; B32B 2553/00; B32B 2439/70; B32B 2439/80; B32B 2307/4026; B32B 2250/04

(57) ABSTRACT

Labels for food, beverage, cosmetic, pharmaceutical, nutraceutical, reagent, or vitamin packaging articles are provided. The labels include a print that is initially hidden, but at a later time period the print or an image within the print becomes visible to the consumer. The print or the image can, for example, include the expiration date of the product. A food, beverage, cosmetic pharmaceutical, nutraceutical, reagent, or vitamin packaging articles is also provided that includes a reservoir having a dye. Upon expiration of the product, the dye is released to taint the product so that a consumer has notice to avoid using the product.

### BACKGROUND

### Field of the Inventions

The inventions are in the field of consumer packaging. More specifically, the inventions are in the field of perishable or nonperishable food, beverage, cosmetic, pharmaceutical, nutraceutical, reagent, and vitamin packaging and labeling.

### Description of the State of the Art

Food, beverage, cosmetic, pharmaceutical, nutraceutical, reagent, and vitamin products do not have an unlimited shelf life. These products include an expiration date or a “sell-by-date” somewhere on the package to alert the consumer that the product has expired or is about to expire, or should no longer be used. An expiration date is commonly very difficult to locate on a bottle or a box; or it is usually written in a very small font, making it practically impossible to notice or read, particularly by the elderly. This is because expiration or sell-by dates are not related to the marketing and selling of the product and, therefore, manufacturers do not want superfluous print on the packaging that makes the labels less aesthetically pleasing to a consumer.

For example, the expiration date is typically located on the bottom of the bottle, and not where it could be easily spotted by the purchaser when looking at a product displayed on the shelf. In other instances, the manufacturer provides the expiration date within the label in a manner that requires one to manipulate or open the label to read the expiration date—making locating the expiration date very cumbersome for the consumer. Some labels are produced under the trade name Timestrip® that have an more complex indicator that moves or is visible over time. The indicator is typically in the form of a line and movement is a function of elapsed time or, in some cases, temperature.

What is needed in the art is visually pleasing packaging labels that allow the expiration date or sell-by-date of the product to be easily and prominently displayed—showing that the product has expired or is about to expire.

### SUMMARY OF THE INVENTIONS

A perishable or nonperishable food, beverage, cosmetic, pharmaceutical, nutraceutical, reagent, or vitamin packaging article is provided. The article comprises an information layer comprising a print that is not visible to a consumer during a period of time, and a cover layer positioned above at least a portion of the information layer. The cover layer is configured to make the print become observable to a consumer at a later point in time. The print is, for example, an expiration date or a sell-by-date of the food, beverage, cosmetic, pharmaceutical, nutraceutical, reagent, or vitamin. In some embodiments, the cover layer obscures the visibility of the print and at the later point in time, at least a portion of the cover layer partially or completely disintegrates to reveal the print. In some embodiments, the cover layer comprises an observable print that obscures the visibility of the print for the information layer; and, at the later point in time, the print for the cover layer at least partially disappears (e.g., fades) to reveal at least a portion of the print for the information layer. The observable print for the cover layer can include an environmentally sensitive toner. The environmentally sensitive toner can be oxygen sensitive, humidity sensitive, thermal sensitive, sensitive to carbon dioxide, or a combination thereof. In some embodiments, the cover layer comprises a toner that at least partially diffuses to the information layer to preferentially color at least a portion of the print for the information layer, such that the preferentially coloring of the print causes an image within the print to be revealed and observable to a consumer. Any of the embodiments can additionally include a base layer below the information layer, the base layer having a print (such as product information).

In accordance with another aspect of the invention, a perishable or nonperishable food, beverage, cosmetic, pharmaceutical, nutraceutical, reagent, or vitamin packaging article is provided. The article comprises a reservoir holding a dye and a cover over the reservoir to contain the dye for a duration of time. Upon expiration of the food, beverage, cosmetic, pharmaceutical, nutraceutical, reagent, or vitamin, the cover disintegrates to expose the food, beverage, cosmetic, pharmaceutical, nutraceutical, reagent, or vitamin to the dye, so that a consumer is alerted that the food, beverage, cosmetic, pharmaceutical, nutraceutical, reagent, or vitamin has expired or should no longer be used.

In accordance with another aspect of the invention, a method of forming a label for a perishable or non-perishable food, beverage, cosmetic, pharmaceutical, nutraceutical, reagent, or vitamin packaging article is provided. The method comprises placing an information layer directly or indirectly on the perishable or nonperishable food, beverage, cosmetic, pharmaceutical, nutraceutical, reagent, or vitamin packaging article, the information layer comprising a print that is not visible to a consumer during a period of time; and placing a cover layer directly or indirectly over the information layer, wherein the cover layer is configured to make the print become observable to a consumer at a later point in time. The print can include an expiration date or a sell-by-date of the food, beverage, cosmetic, pharmaceutical, nutraceutical, reagent, or vitamin. In some embodiments, the cover layer obscures the visibility of the print and at the later point in time, at least a portion of the cover layer partially or completely disintegrates to reveal the print. In some embodiments, the cover layer comprises an observable print that obscures the visibility of the print for the information layer. At the later point in time, the print for the cover layer at least partially disappears (e.g., fades) to reveal at least a portion of the print for the information layer. The observable print for the cover layer can be an environmentally sensitive toner. The environmentally sensitive toner can be oxygen sensitive, humidity sensitive, thermal sensitive, sensitive to carbon dioxide, or a combination thereof. In some embodiments, the cover layer comprises a toner that at least partially diffuses to the information layer to preferentially color at least a portion of the print for the information layer, such that the preferentially coloring of the print causes an image within the print to be revealed and observable to a consumer. Any of the embodiments can additionally include placing a base layer over the article prior to placing the information layer, the base layer having a print (such as product information).

### BRIEF DESCRIPTION OF THE DRAWINGS

FIG. 1 is an embodiment of the present inventions illustrating an example of multiple layers for labels.

FIG. 2 is an embodiment of the present inventions illustrating an example of multiple layers for labels.

FIG. 3 is an embodiment of the present inventions showing the label arrangement in reverse order.

FIG. 4 illustrates a sample implementation of an embodiment of the present invention.

FIG. 5 is another embodiment of the present inventions, showing various layers of different sizes.

FIG. 6 is another embodiment of product label layering configuration of the present inventions.

FIG. 7 is another embodiment of product label layering configuration of the present inventions.

FIG. 8 is another embodiment of product label layering configuration of the present inventions.

FIG. 9 is another embodiment of product label layering configuration of the present inventions.

FIG. 10 is another embodiment of product label layering configuration of the present inventions.

FIGS. 11A-11C illustrate side and top views of another embodiment of the product label layering configuration of the present inventions.

The Figures have not been provided to scale and the illustrated sizes and dimensions are intended to be illustrative.

### DETAILED DESCRIPTION OF THE INVENTION

The phrase “as used herein” encompasses all of the specification, the abstract, the drawings, and the claims.

As used herein, the use of the singular includes the plural and vice-versa unless expressly stated to be otherwise, or obvious from the context that such is not intended. That is, “a” and “the” refer to one or more of whatever the word modifies. For example, “a layer” may refer to one layer, two layers (e.g., sublayers), etc. Likewise, “the product” may refer to one, two, or more products. Similarly, words such as, without limitation, “products” would refer to one product as well as to a plurality of products unless it is expressly stated or obvious from the context that such is not intended.

As used herein, unless specifically defined otherwise, any words of approximation such as without limitation, “about,” “essentially,” “substantially,” and the like mean that the element so modified need not be exactly what is described but can vary from the description. The extent to which the description may vary will depend on how great a change can be instituted and have one of ordinary skill in the art recognize the modified version as still having the properties, characteristics, and capabilities of the unmodified word or phrase. With the preceding discussion in mind, unless stated otherwise, a numerical value herein that is modified by a word of approximation may vary from the stated value by ±15% in some embodiments—preferably by ±10%, and most preferably by ±5% As used herein, all numbers that represent physical values or measurements are subject the standard deviation in the measurement of the value.

As used herein, “optional” means that the element modified by the term may or may not be present.

As used herein, the phrases “any combination of” and “a combination of” followed by a list joined by the conjunction “and,” means any combination of two or more members of the group where the group members are the members of the list joined by the conjunction “and.” As a non-limiting example, “any combination of A, B, C, and D” encompasses the following combinations: A and B; A and C; A and D; B and C; B and D; C and D; A, B, and C; A, B, and D; A, C, and D; B, C, and D; and/or A, B, C, and D. Similarly, the phrase “A, B, C, D, or any combination thereof” encompasses an individual member (A, B, C, D) or any combination of A, B, C, and D, as outlined above. The phrase “A, B, C, D, or a combination thereof” encompasses an individual member (A, B, C, D) or any combination of A, B, C, and D, as outlined above. Similarly, the phrase “X is selected from the group consisting of A, B, C, D, and combinations thereof” (or a variant such as “X is selected from the group consisting of A, B, C, D, and all combinations thereof”) encompasses X being an individual member of the group (A, B, C, D) or any combination of the A, B, C, and D, as outlined above. Although already encompassed by the description of singular and plural above, the terms “an individual member” and A will each be explicitly defined to encompass one or more members of A, if A is a genus, in the description above. Likewise, if B is a genus, “an individual member” and B each encompass one or more members of B in the above description, etc.

As used herein, the phrase “and/or” means a combination or an individual member. As a non-limiting example, “X is A, B, and/or C” encompasses the following possibilities: X is A; X is B; X is C; X is any combination of A, B, and C (A and B; A and C; B and C; A, B, and C). Although already encompassed by the description of singular and plural discussed above, it will explicitly be stated that if A is a genus, “an individual member” and A each encompass one or more members of A. Thus, as applied to the above non-limiting example, “X is A, B, and/or C” encompasses X is one or members of A; X is B; X is C; X is any combination of A, B, and C (B and one or more members of A; C and one or more members of A; B and C; B, C, and one or more members of A). In a likewise manner, “one or members of B” would apply if B were a genus, and the same for C, if C were a genus, etc.

A “layer” (or “film”—used interchangeably herein) has a thickness much smaller (at least about 1/10, preferably at least about 1/25, and in some embodiments at least about 1/50) than the other dimensions (diameter, or width and/or length). As used herein, a material that is described as a layer or a film applied to an indicated substrate refers to a thin layer of the material deposited or placed directly or indirectly over at least a portion of the surface of the substrate. A layer “directly deposited” means that the material is applied directly to the surface of the substrate/layer (i.e., surface-to-surface contact). A layer “indirectly deposited” means that the material is applied to an intervening layer that has been deposited or placed directly or indirectly over the substrate/layer. A layer may be formed by one or multiple applications of material or sublayers. A layer may be continuous, discontinuous, or have holes or gaps in a layer.

As used herein, “above” a surface or layer is defined as further from the substrate measured along an axis normal to a surface, or over a surface or layer, but not necessarily in contact with the surface or layer.

As used herein, “below” a surface or layer is defined as closer to the substrate measured along an axis normal to a surface, or under a surface or layer, but not necessarily in contact with the surface or layer.

As used here, the terms “toner,” “ink,” and “dye” (used herein interchangeably unless otherwise specifically stated) have the meaning that would be understood in the printing industry.

As used herein, a “polymer” refers to a molecule comprised of, actually or conceptually, repeating “constitutional units.” The constitutional units derive from the reaction of monomers. As a non-limiting example, ethylene (CH₂═CH₂) is a monomer that can be polymerized to form polyethylene, CH₃CH₂(CH₂CH₂)ₙCH₂CH₃ (where n is an integer), wherein the constitutional unit is —CH₂CH₂—, ethylene having lost the double bond as the result of the polymerization reaction. The constitutional units themselves can be the product of the reactions of other compounds. A polymer may be derived from the polymerization of several different types of monomers or may be formed of several different types of constitutional units. Such polymers are referred to as “copolymers.” Those skilled in the art, given a particular polymer, will readily recognize the constitutional units of that polymer and will readily recognize the structure of the monomer from which the constitutional units derive. As used herein, the term polymer refers to a molecule comprising more than 20 constitutional units.

Polymers may be straight or branched chain, star-like or dendritic, or one polymer may be attached (grafted) onto another. Polymers may have a random disposition of constitutional units along the chain, the constitutional units may be present as discrete blocks, or constitutional units may be so disposed as to form gradients of concentration along the polymer chain. In other words, the polymers used in this invention may be regular alternating polymers, random alternating polymers, regular block polymers, random block polymers, or purely random polymers unless expressly noted otherwise. Polymers may be cross-linked to form a network.

As used herein, a molecule that has a chain length of 20 or fewer constitutional units is referred to as an “oligomer.”

Embodiments of the present invention encompass perishable or nonperishable food, beverage, cosmetic, pharmaceutical, nutraceutical, reagent, and vitamin articles (e.g., packaging, packets, containers, boxes, and cartons—terms used herein interchangeably) with printed material of product information—particularly an expiration date or “sell-by-date”—that is not visible during a period of time, but becomes visible at a later or designated point in time. Embodiments of the present invention encompass articles including two or more layers, where some printed material is not visible on the article during a period of time, but at least a portion of the printed material becomes visible at a later or designated point in time. As used herein, the term “printed material” or “print” refers to indicia, text, images, symbols, logos, designs, or combinations thereof, placed on a layer over a substrate or on surface of the substrate. As use herein, the term “visible” refers to something that can be seen by a human consumer with normal light in ordinary shopping conditions (for example, the light from a 100 W incandescent bulb at arm's length of about 1-4 feet).

Embodiments of the present invention encompass articles including two or more layers. One layer can be designated as an information layer including printed material. Another layer can be designated as a cover layer above at least a portion of the layer including printed material. The cover layer obscures at least a portion of the printed material that would otherwise be visible at one point in time. The cover layer is designed to reveal at least a portion of the printed material (that was previously obscured) at a later or designated point in time. As used herein, the term “obscure” means to fully block, partially block, not make visible, not make noticeable, or not make detectable. Visible printed material can be obscured by being covered with an opaque layer or covering that blocks light. Visible printed material can be obscured by being covered with a transparent or translucent covering including a “busy” design. In some embodiments, at least a portion of the cover layer disintegrates over time such that at the later or designated point of time, at least a portion of the printed material becomes visible. As used herein, with respect to a disintegrating cover layer or a disintegrating material, “disintegrate” can mean to lose structural integrity and become multiple smaller particles or dust-like waste powder.

In some embodiments, the cover layer includes printed material including a “disappearing ink,” and thus allows for at least a portion of the printed material in the information layer below the cover layer to be at least partially visible after the ink disappears (e.g., fades). As used herein, the term “disappearing” when used in reference to an ink, writing, and/or printed material refers to an ink, writing, and/or printed material that is visible when initially formed, but at some later point is not visible or fades away.

In some embodiments, the information layer includes “printed material” where initially the printing is of the same color tone as the background (and thus is not clearly visible), and the cover layer includes an ink or toner that “bleeds” (e.g. diffuses) over time into the layer below to preferentially dye or stain the printed material so it becomes visible and distinguishable from the background at a later or designated point in time.

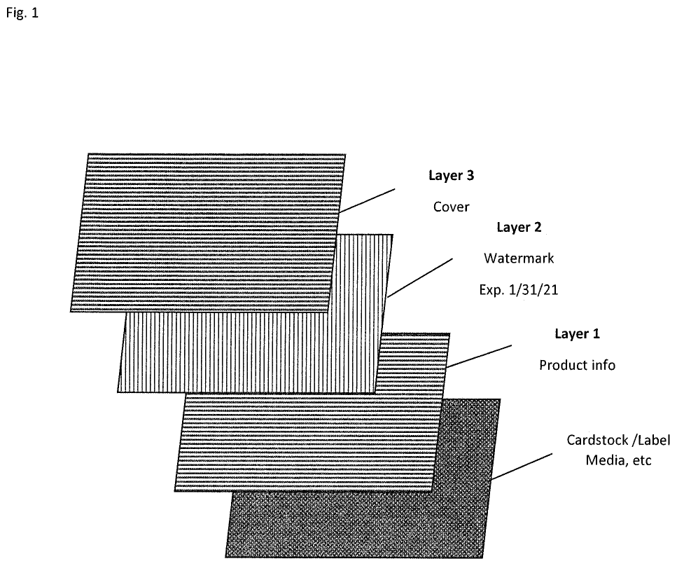

One embodiment of the present invention is shown in FIG. 1 where there is a substrate labeled as “Cardstock/Label Media, etc.”; a base layer labeled “Layer 1: Product info” and is intended to include printed material representative of the product (indicia, text, images, symbols, logos, designs, or combinations thereof); an information layer labeled “Layer 2: Watermark” that includes a printing of the expiration date, “Exp. Jan. 31, 2021”; and, a cover layer, labeled “Layer 3: Cover.” In some embodiments, the cover layer 3 as shown in FIG. 1 can include a duplicate of the printed material of the base layer 1. Initially, the expiration date, “Exp. Jan. 31, 2021,” is not visible, but at or right before the time of product expiration, the expiration date becomes clearly visible. Other layers may be present such as, but not limited to, adhesive layers and/or release layers (described below).

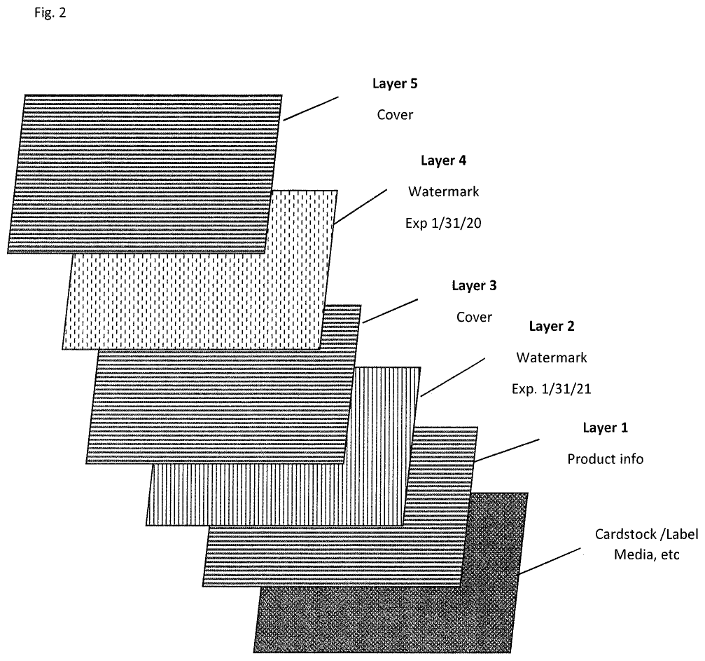

Embodiments of the present invention encompass articles including two or more layers, where some printed material is not visible on the article for a duration of time, but at least a portion of the printed material become visible at a later or designated point in time, and the article includes two or more pairs of information layers and cover layers. An embodiment is illustrated in FIG. 2, where there is a substrate labeled as “Cardstock/Label Media, etc.”; a base layer labeled “Layer 1: Product info” and is intended to include printed material representative of the product (indicia, text, images, symbols, logos, designs, or combinations thereof); a second layer labeled “Layer 2: Watermark” that includes information, the expiration date, “Exp. Jan. 31, 2021”; a third layer labeled “Layer 3: Cover”; a fourth layer labeled “Layer 4: Watermark” that includes information, the expiration date, “Exp. Jan. 31, 2020”; and a cover layer, labeled “Layer 5: Cover.” It is understood that embodiments of the present invention can include additional pairs of information layers/cover layers above the 5^{th} layer as shown in FIG. 2. In some embodiments, there are multiple pairs of information layers and cover layers stacked on top of each other. In this manner, the outermost cover layer/information layer pair may be removed leaving the subsequent cover layer/information layer pair where the remaining information layer includes different printed material (information) than the printed material on the removed information layer. In some embodiments, the mechanism of revealing the information in the information layer/cover layer pair (disintegrating layer; disappearing ink; diffusing/bleeding ink) may be the same for all information layer/cover layer pairs of the article, and in other embodiments, there may be more than one mechanism of action if there is more than one information layer/cover layer pair present.

In some embodiments, the information layer is used to display only one type of printed material—preferably an expiration date or “sell-by-date.” In other embodiments, the information layer is used to display more than one type of printed material—preferably an expiration and/or product information. The cover layer can have an observable print that is the same as a print of the base layer. Some portion of the printed material on the information sheet can be initially visible and the remaining portion is not visible until a later or designated point of time. The printed material on the base layer and/or information layer can be formed using a material including a permanent ink or toner. As used herein, “permanent” ink or toner means that the printed material is visible over the expected lifetime of the product, under typical or normal circumstances—and not subjected to unordinary conditions that would degrade the ink or toner.

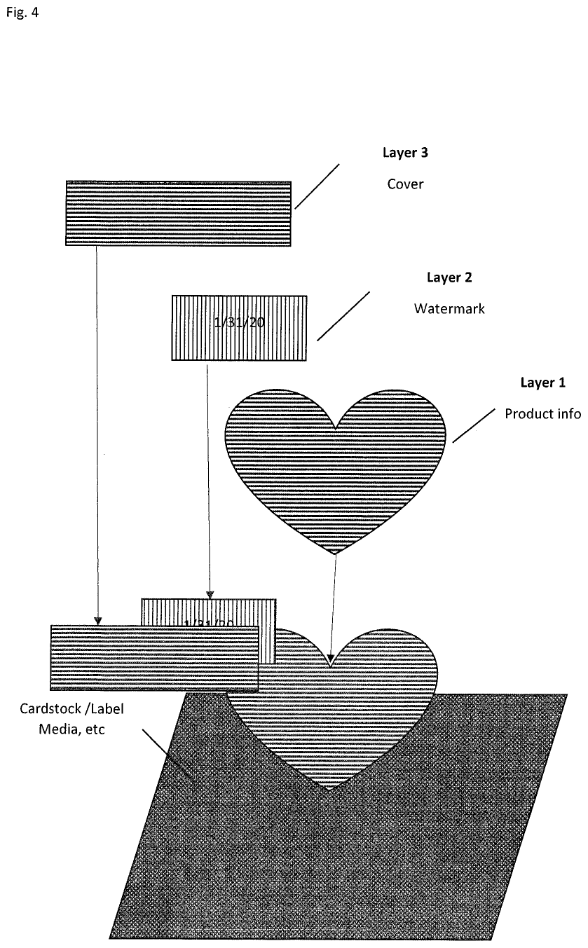

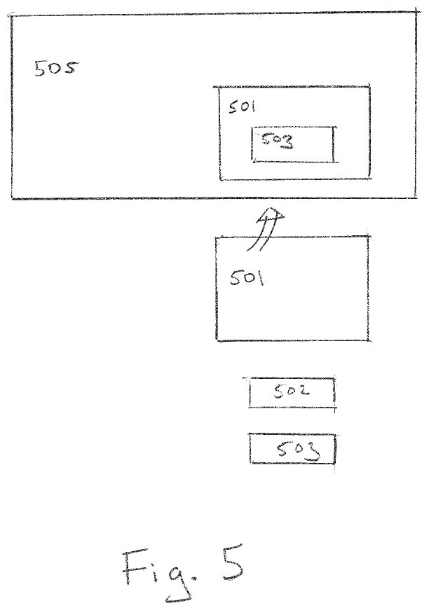

Embodiments of the present invention encompass articles where the different layers may be the same size and shape. Alternatively, one or a combination of the layers can be of different size and shape so long as the sizing and shaping of the layers allows the objectives of the inventions to be met. The layers may be of different thickness. An exemplary embodiment is shown in FIG. 4 where there is a substrate labeled as “Cardstock/Label Media, etc.”; and a heart shaped base layer labeled “Layer 1: Product info” and is intended to include printed material representative of the product (indicia, text, images, symbols, logos, designs, or combinations thereof). As shown in FIG. 4, there is a rectangular shaped information layer labeled “Layer 2: Watermark” that includes information, the expiration date, “Exp. Jan. 31, 2020,” and a larger rectangular shaped cover layer, labeled “Layer 3: Cover.” For the embodiment illustrated in FIG. 4, both layers 2 and 3 have a smaller surface area than layer 1, and layer 2 has a smaller surface area than layer 3 when viewed top-down. Another non-limiting example is shown in FIG. 5 where 505 is the substrate, 501 is the base layer, 502 is the information layer, and 503 is the cover layer. When stacked and adhered to a product, cover layer 503 covers the entire information layer 502. As shown in FIG. 5, the information layer 502 and cover layer 503 are not the same size as the base layer 501.

As discussed above, in some embodiments, the cover layer is designed to partially or completely disintegrate over time so as to show or reveal the designated information (e.g., expiration date or sell-by-date). The cover layer, or at least a portion of the cover layer, can be formed of one or more materials, at least one of the materials capable of disintegrating over time. The one or materials that is designed to disintegrate can be at least about 75 wt % (% by weight) of the cover layer or at least about 75 vol % (% by volume) of the cover layer material. The one or more materials that disintegrate can form a continuous phase of the cover layer, and the remaining materials in the cover layer, either individually or in combination, do not form a continuous phase. The cover layer includes a quantity of the one or more materials that disintegrate so that the cover layer completely disintegrates (with minimal amount of residues left behind) or at least a portion of the cover layer disintegrates to show the designated print. Examples of materials that disintegrate include the types of polymers or materials designated as biodegradable and/or compostable. Non-limiting examples of biodegradable polymers include aliphatic polyesters, and natural polymers such as starch and cellulose. Polymers or materials that degrade and/or disintegrate when exposed to oxygen and/or humidity in air are preferably used. In some embodiments, additives to change the pH, additives to increase or decrease the rate of water absorption, oxygen absorption, etc., and/or additives that otherwise change the degradation rate may be included in the cover layer.

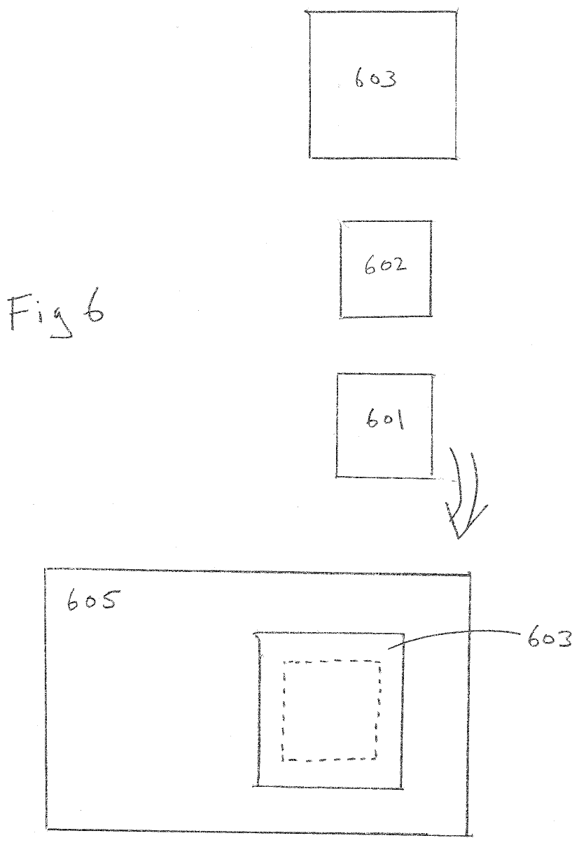

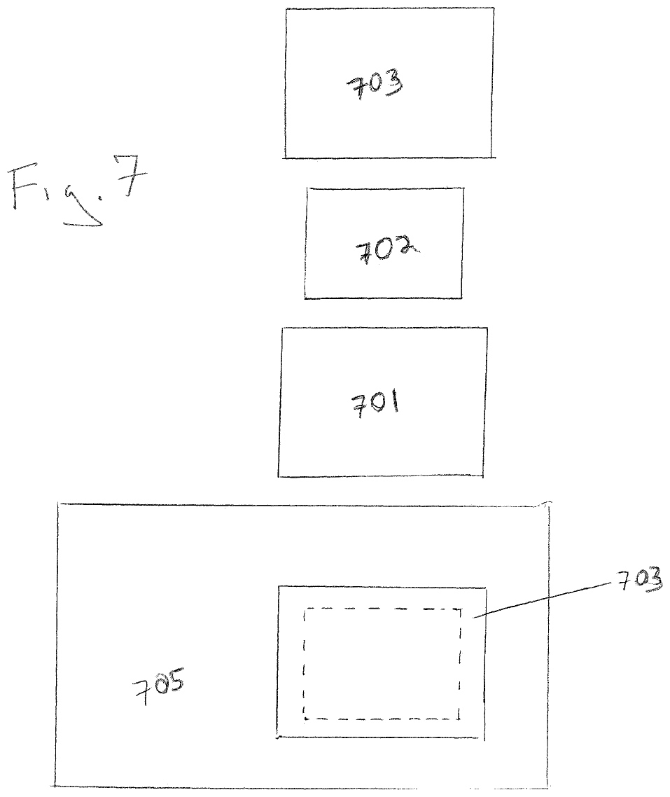

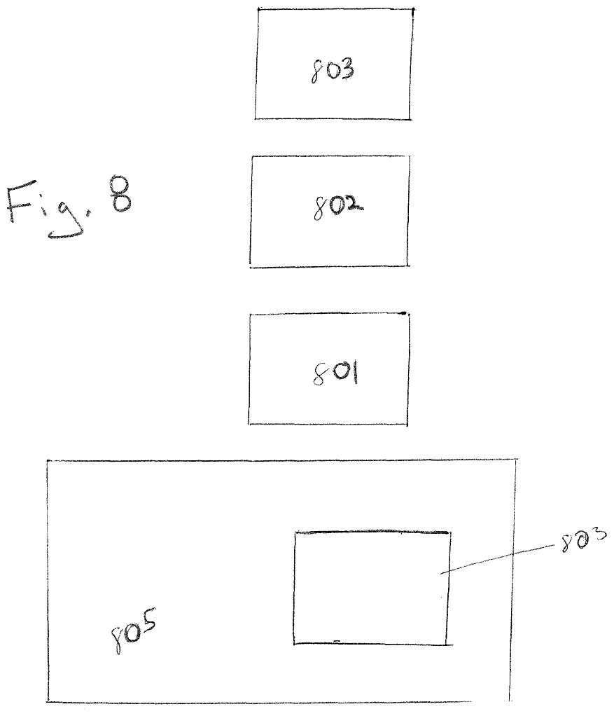

In some embodiments, the entirety of the cover layer is capable of disintegrating. Obviously if an adhesive is used on either side of the cover layer—such as, for example, around the perimeter boarder of the cover layer—the areas of the cover layer which include the adhesive material may remain on the package and not disintegrate. Accordingly, the adhesive material should not be used over the portion of the information layer that is designed to be displayed after a period of time. In one example, the cover layer may be slightly larger in area than the information layer and optional the base layer, and only the edges of the cover layer are attached to the substrate, the information layer, and/or the optional base layer as shown in FIGS. 6-8. Referring to FIGS. 6-8, 605, 705, and 805 refer to the substrate; 601, 701 and 801 refer to the base layer; 602, 702, and 802 refer to the information layer; and 603, 703, and 803 refer to the cover layer. In FIG. 6, the edges of the cover layer 603 are attached to the substrate 605 over the other two layers where the dotted lines show the outline of the base and information layers 601 and 602. In FIG. 7, the information layer 702 is sandwiched between the base layer 701 and the cover layer 703 where the cover layer 703 is adhered to the base layer 701 by an adhesive known in the art. The dotted line shows the outline of information layer 702 beneath the cover layer 703. In FIG. 8, all three layers 801, 802 and 803 are stacked—so that only the cover layer 803 is visible at the top. The cover layer 803 is attached at the edges only to information layer 802, and information layer 802 can be adhered to the base layer 801.

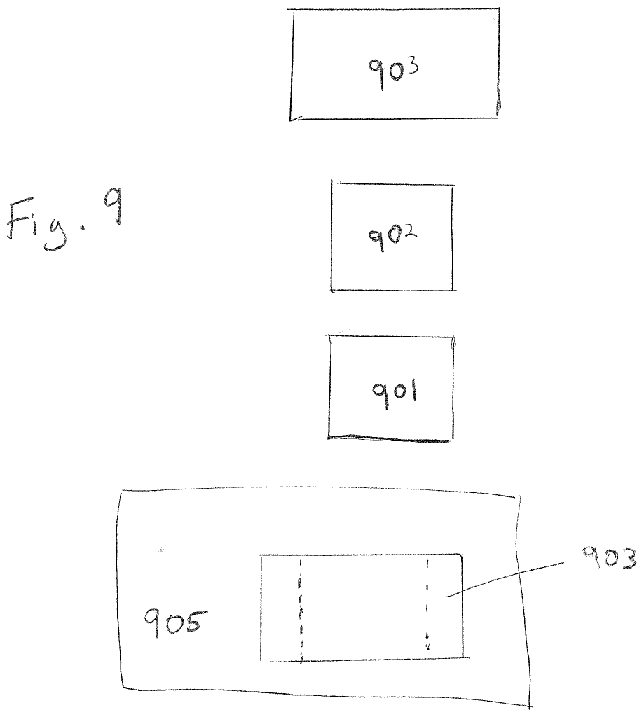

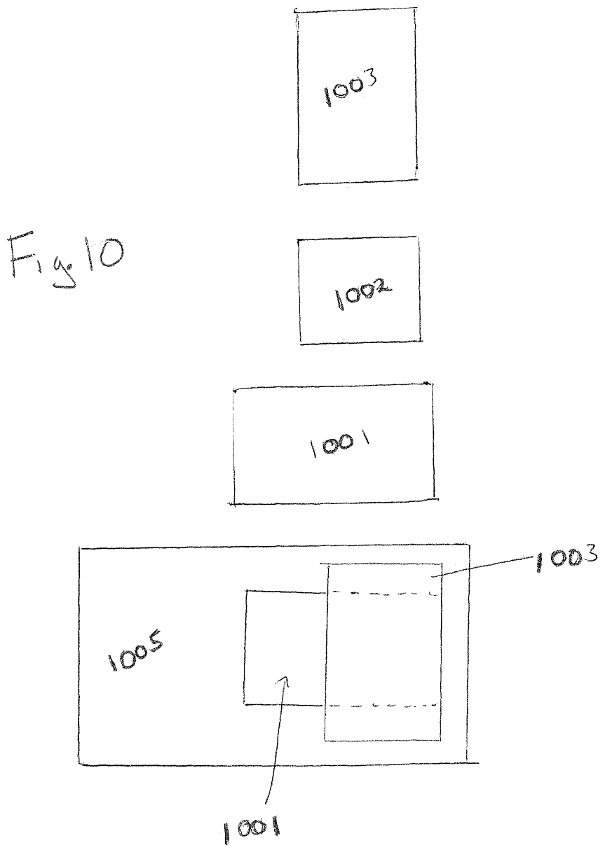

In another embodiment, only two of the outer edges of the cover layer 903 may be adhered to the base layer 901, information layer 902, and/or substrate 905. As shown in FIGS. 9 and 10: 905 and 1005 refer to the substrate, 901 and 1001 refer to the base layer, 902 and 1002 refer to the information layer, and 903 and 1003 refer to the cover layer. The two outer edges of the cover layer 903 are adhered to the substrate 905/1005 with either the entire base layer 901/1001 or a section of the base layer 901/1001 being below the cover layer 903/1003. The information layer 902/1002 is entirely below the cover layer 903/1003 and above the base layer 901/1001. Only a “window” of the cover layer is not adhered to the information layer so as to allow the material of the cover layer to disintegrate and expose the relevant data (e.g., expiration date) formatted on the information layer. One skilled in the art can readily appreciate that other variations are possible provided that the printed material intended to be hidden initially is covered with a cover layer and at least a portion of the cover layer disintegrates to reveal at least a portion of the printed material on the information layer. In some embodiments, if the cover layer at least partially disintegrates, an adjacent layer can be a release layer or includes a “release” material, such as silicone, to prevent the disintegrating layer from adhering to the adjacent layer.

In some embodiments the cover layer includes a “disappearing ink.” Disappearing inks interact with the environment to form a compound that has no color or a different color. Disappearing inks are also referred to as environmentally sensitive toners, and may be sensitive to something in the environment that results in a color change. Environmentally sensitive toners may be sensitive to oxygen, carbon dioxide, and/or humidity in the environment, and/or may be thermally sensitive. Non-limiting examples of disappearing inks (environmentally sensitive toners) are a combination of sodium hydroxide and thymolphthalein, and a combination of sodium hydroxide and phenolphthalein. Other formulations of environmentally sensitive toners are known in the art. The environmentally sensitive toner and the material of the cover layer are chosen such that the printed material formed with the environmentally sensitive toner disappears at the appropriate time, such as the expiration date of the product. In some embodiments, the cover layer includes an environmentally sensitive toner, and a layer above the environmentally sensitive toner limits the diffusion of oxygen, carbon dioxide, water, etc. to at least partially control the time frame when the toner is not visible. Here, the “cover layer” can be defined as having two “sub-layers.” In some embodiments, the “disappearance” and/or time when the toner is not visible is determined by measuring the absorbance in a spectrophotometer over the visible wavelength and/or the change at one or more specific wavelengths. The one or more specific wavelengths are the wavelengths characteristic of the particular dye or toner color. As a non-limiting example, if thymolphthalein is used, it may be monitored at 600 nm.

In some embodiments, the information layer includes printed material or print (e.g., expiration date) where initially the printing is of the same color tone as the background, and thus is not clearly visible. The cover layer includes an ink or toner that “bleeds” (e.g. diffuses) over time into the layer below to preferentially dye or stain the printed material so the print or an image in the print becomes visible at a later point in time. Essentially, the information layer includes a “hidden message” and/or “hidden design” that is later revealed. The information layer may be made by forming a layer (background layer) into which is printed a material including one or more compounds that absorb and/or uptake a dye more than the material of the background. The cover layer includes a dye that then diffuses over time to the layer below. In some embodiments, the dye does not diffuse until a certain degree of interaction with an environmental element, such as oxygen, humidity, etc. In some embodiments, there is an intermediate layer between the cover layer and the information layer that limits or controls the time frame of diffusion of the ink (and/or the cover layer and/or information layer is actually two layers). In some embodiments, the ink in the cover layer that diffuses into the information layer is in the form of a design, text, or symbol that becomes no longer visible once enough ink has diffused. As one example, a frame or border of dye or toner around text in a cover layer may diffuse to the information layer to dye one or more materials in the information layer, and thus, the border in the cover layer may no longer exist or may be significantly fainter. In some embodiments, there is a layer above the cover layer (top or protective layer) to prevent the ink from subliming and/or being rubbed off onto other materials. As a non-limiting example, Lugol iodine solution (includes potassium triiodide (KI₃)) is known to turn starch blue, and thus a starch based printing would absorb/adsorb the Lugol iodine solution. In some embodiments, the cover layer is or includes a hydrogel type material such that the dye moves when humidity is absorbed by the hydrogel. Thus, the cover layer may be formed of one or more materials where one of the materials is a hydrogel or capable of forming a hydrogel. Non-limiting examples include polyvinyl alcohol, polyethylene glycol, polyethylene oxide, copolymers of other polymers and polyethylene glycol, copolymers of other polymers and polyethylene oxide, chitosan, dextran, pullulan, carboxymethyl curdlan, polymers and copolymers of acrylic acid, polymers and copolymers of methacrylic acid, and other polymers capable of absorbing water.

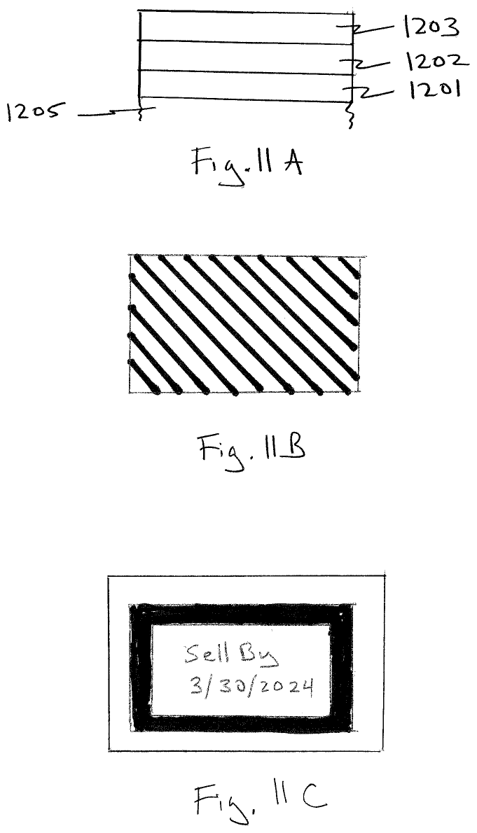

In some embodiments, the article is a variation of the embodiments described above, but instead of or in addition to a “hidden message,” the information layer includes “printed material” made using a permanent ink (and is clearly visible), and the cover layer includes an ink or toner that “bleeds” (e.g. diffuses) over time into the layer below. In some embodiments, the cover layer includes a “busy” design of dye, and the information layer below includes a material that preferentially uptakes the dye and forms instead of or in addition to a hidden message, a frame, border, or other design that does not interfere with the printed material in permanent ink. Thus, over time, the cover layer becomes transparent or translucent as the dye migrates, revealing the printed material in permanent ink below. A non-limiting example is illustrated in FIG. 11, where FIG. 11A shows a cross-sectional view of the three layers, FIG. 11B shows the initial top view, with a busy striped pattern visible on layer 1203, and FIG. 11C, shows the top view after the toner has moved from the stripes in layer 1203 to the border in layer 1202, revealing the expiration date on layer 1202. The same types of materials would be used as those described above.

In the embodiments of the present invention that use a dye that can migrate from one layer to another, if adhesive are used, the adhesive will be applied to permit the migration of the dye.

One skilled in the art can appreciate that “not visible” can be replaced with “at least partially obscured” at one point in time, and “visible” can be replaced with “at least less obscured.” Embodiments of the present invention encompass labels for perishable or nonperishable food, beverage, cosmetic, pharmaceutical, nutraceutical, reagent, and vitamin packaging and containers which require printed material—and more specifically an expiration date or sell-by-date—that can be at least partially obscured or completely obscured at one point in time, but become less obscure or preferably prominently displayed at an elected or later point of time. As used herein, “at least partially obscured” means the printed material is not clearly visible, but can be seen or read if very closely observed; and “at least less obscured” means it is much easier to see and read than initially.

Embodiments of the present invention also encompass a dye device or package that releases dye at a specific time. As a non-limiting example, the device may be placed in a bottle of tablets including an active pharmaceutical ingredient (API) where the device is designed to release the dye at the time of the expiration of the API. In some embodiments, API includes over the counter medications sold in the United States, prescription medications for humans and/or animals approved by the United States Food and Drug Agency (US FDA), prescription medications for humans and/or animals approved by other jurisdictions such as, but not limited to, Europe, Japan, Canada, and Australia, for example. Thus, embodiments of the present invention encompass articles including a reservoir including a dye, and a layer covering the reservoir (cover layer) where the device is designed such that the cover layer fails or disintegrates to release the dye. As used herein, with respect to a dye product, “contained” means the dye is not free to migrate away from the device, and/or there is negligible (<1 wt %) loss of the dye. “Not contained” means the dye can migrate/diffuse out of the device/package such that at least 5 wt % (preferably at least 10 wt %) of the dye is lost from the device over a 24 hour period. In one particular embodiment, the reservoir is a layer containing or carrying the dye, with a cover layer above the dye layer. In some embodiments, the reservoir includes a dye and a polymer, with or without a binder. In some embodiments, there is a base layer below the dye layer that prevents the dye from diffusing in the opposite direction, and also serves as a substrate for supporting the dye layer. In some embodiments, the base layer includes an adhesive on the side opposite of the dye layer, so that the device can be adhered to the interior of a package such as a bottle of tablets. In some embodiments, the device includes a cup (or recess) to hold the dye, and a cover sheet over the top and sealed around the top edge of the cup. The cover sheet can include a compound that reacts with an item inside the package.

Embodiments of the present invention include methods of making the articles and devices as described herein. The methods may include application of one or more layers to a substrate. The layers may be applied by a printing process. Other methods of applying layers include, but are not limited to, spraying, dipping, electrostatic coating, chemical vapor deposition, use of a controlled-volume ejector, extrusion, molding, lamination, direct fluid application, use of a roller, use of a brush, ink-jet application, or any combination thereof. Multiple applications of material may be used to form an individual layer, particularly if a solvent is used in the application (that is subsequently removed, except residual solvent levels). In some embodiments, nominal levels of materials may migrate between layers during application and/or after the layers are formed. In some embodiments, adhesive layers or strips are applied between layers.

Various methods of making a dye pack are also within the purview of the present inventions. In some embodiments, a base is formed of a polymer and filled with a dye; then a cover layer is applied to control the release of the dye. The device can be similar to the three layers shown in FIG. 1 where the substrate is a release paper/adhesive roll combination that is applied to the inside or a bottle or container. In some embodiments, the three layers may be sealed around the edges such as by heat sealing or use of an adhesive. In some embodiments —referring to FIG. 1 as one example—layer 2 is of smaller surface area such that a seal can be formed between layers 1 and 3 to encapsulate layer 2 (also see, FIG. 7). The seal may be formed by methods such as but not limited to heat sealing or use of an adhesive. On the other side of layer 1, a layer of adhesive can be used to adhere the device to the inside of a container. Methods of preparing the various layers and sealing the various layers are known in the art. Adhesives for attaching labels are also known in the art. In some embodiments, the “base layer” is a cup-shaped device that may be made by molding, thermoforming, or pressing.

In the articles and devices described herein, the substrate may be cardboard or cardstock used in packaging. However, the type of substrate is not limited and it may include wood, paper, cardboard, plastic, glass, metal (e.g., aluminum), or a combination thereof. In some embodiments, the substrate can be a roll of blank labels attached to a paper or release sheet, and additional layers are formed on top of the initial label. In the embodiments of the present invention, the base layer may be formed of materials including polymers known for forming films—examples include: polyethylene, polypropylene, polyethylene terephthalate, and combinations thereof. In some embodiments, the substrate is polymer coated cardboard or paper. The information layer and/or the background portion of the information layer may be formed of any one or more of the above polymers. The information and/or cover layers can be translucent or transparent. The layers and the substrate of the articles and devices described herein may include additional materials such as but not limited to plasticizers and other additives.

The following example is given to aid in understanding the invention, but it is to be understood that the invention is not limited to the particular materials or procedures of the example.

### Example

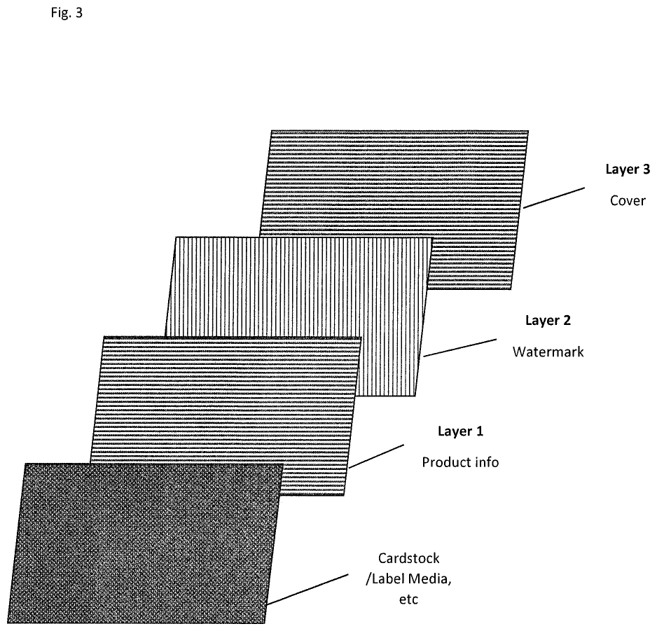

A three layer label can be formed for placement on a substrate, such as a cardstock used in packaging. An example is shown in FIG. 3, where the first layer 1, directly on the substrate, can be formed of polyethylene and includes product information (printed material). A second layer 2 formed above the first layer 1 includes printed starch to form a hidden message and/or design. A third layer 3 formed above the second layer includes Lugol iodine solution (potassium triiodide (KI₃)) in a hydrogel (e.g., polyethylene glycol). Upon exposure to ambient humidity, the KI₃ in the hydrogel will diffuse to the second layer 2 and dyes the starch. The starch being present in the form of a symbol or text, appears after some time.

While particular embodiments of the present invention have been shown and described, it will be obvious to those skilled in the art that changes and modifications can be made without departing from this invention in its broader aspects. Therefore, the appended claims are to encompass within their scope all such changes and modifications as fall within the true spirit and scope of this invention.

What is claimed is:

1. A food, beverage, cosmetic, pharmaceutical, nutraceutical, reagent, or vitamin packaging article comprising:
an information layer comprising a print that is not visible to a consumer during a period of time; and
a cover layer positioned above at least a portion of the information layer, wherein the cover layer is configured to make the print become observable to a consumer at a later point in time.

2. The article of claim 1, wherein the print includes an expiration date or a sell-by-date of the food, beverage, cosmetic, pharmaceutical, nutraceutical, reagent, or vitamin.

3. The article of claim 1, wherein the cover layer obscures the visibility of the print and at the later point in time, at least a portion of the cover layer partially or completely disintegrates to reveal the print.

4. The article of claim 1, wherein the cover layer comprises an observable print that obscures the visibility of the print for the information layer; and wherein at the later point in time, the print for the cover layer at least partially disappears to reveal at least a portion of the print for the information layer.

5. The article of claim 4, wherein the observable print for the cover layer comprises an environmentally sensitive toner, the environmentally sensitive toner being oxygen sensitive, humidity sensitive, thermal sensitive, sensitive to carbon dioxide, or a combination thereof.

6. The article of claim 1, wherein the cover layer comprises a toner that at least partially diffuses to the information layer to preferentially color at least a portion of the print for the information layer, such that the preferentially coloring of the print causes an image within the print to be revealed and observable to a consumer.

7. The article of claim 1, additionally comprising a base layer below the information layer, the base layer having a print.

8. The article of claim 1, wherein the cover layer comprises an observable print that is the same as the print of the base layer.

9. The article of claim 1, additionally comprising:
a second information layer, above the cover layer, and having a print that is not visible to a consumer during a period of time; and
a second cover layer positioned above at least a portion of the second information layer, wherein the second cover layer is configured to make the print of the second information layer to become observable to a consumer at a later point in time.

10. The article of claim 1, wherein the cover layer comprises an adhesive region along at least one side of the cover layer to allow the cover layer to adhere to the information layer, a base layer below the information layer, or the article itself.

11. A food, beverage, cosmetic, pharmaceutical, nutraceutical, reagent, or vitamin packaging article comprising:
a reservoir holding a dye;
a cover over the reservoir to contain the dye for a duration of time;
wherein upon expiration of the food, beverage, cosmetic, pharmaceutical, nutraceutical, reagent, or vitamin, the cover disintegrates to expose the food, beverage, cosmetic, pharmaceutical, nutraceutical, reagent, or vitamin to the dye, so that a consumer is alerted that the food, beverage, cosmetic, pharmaceutical, nutraceutical, reagent, or vitamin has expired.

12. A method of forming a label for a food, beverage, cosmetic, pharmaceutical, nutraceutical, reagent, or vitamin packaging article comprising:
placing an information layer directly or indirectly on the perishable food, beverage, cosmetic, pharmaceutical, nutraceutical, reagent, or vitamin packaging article, the information layer comprising a print that is not visible to a consumer during a period of time;
placing a cover layer directly or indirectly over the information layer, wherein the cover layer is configured to make the print become observable to a consumer at a later point in time.

13. The method of claim 12, wherein the print includes an expiration date or a sell-by-date of the food, beverage, cosmetic, pharmaceutical, nutraceutical, reagent, or vitamin.

14. The method of claim 12, wherein the cover layer obscures the visibility of the print and at the later point in time, at least a portion of the cover layer partially or completely disintegrates to reveal the print.

15. The method of claim 12, wherein the cover layer comprises an observable print that obscures the visibility of the print for the information layer; and wherein at the later point in time, the print for the cover layer at least partially disappears to reveal at least a portion of the print for the information layer.

16. The method of claim 15, wherein the observable print for the cover layer comprises an environmentally sensitive toner, the environmentally sensitive toner being oxygen sensitive, humidity sensitive, thermal sensitive, sensitive to carbon dioxide, or a combination thereof.

17. The method of claim 12, wherein the cover layer comprises a toner that at least partially diffuses to the information layer to preferentially color at least a portion of the print for the information layer, such that the preferentially coloring of the print causes an image within the print to be revealed and observable to a consumer.

18. The method claim 12, additionally comprising placing a base layer over the article prior to placing the information layer and below the information layer, the base layer having a print.

19. The method of claim 12, additionally comprising:
placing a second information layer above the cover layer, the second information layer having a print that is not visible to a consumer during a period of time; and
placing a second cover layer above at least a portion of the second information layer, wherein the second cover layer is configured to make the print of the second information layer to become observable to a consumer at a later point in time.

20. The method of claim 12, wherein the cover layer comprises an adhesive region along at least one side of the cover layer to allow the cover layer to adhere to the information layer, a base layer below the information layer, or the article itself.
